(19) United States
(12) Patent Application Publication
(10) Pub. No.: US 2015/0365131 A1
(43) Pub. Date: Dec. 17, 2015

(54) Crosstalk Management For OFDM Communication Systems In Power Efficient Transmission Mode

(71) Applicant: Metanoia Communications Inc., Hsinchu (TW)

(72) Inventors: Chun-Che Chang, Hsinchu (TW); Ravi Mantri, Portland, OR (US)

(21) Appl. No.: 14/832,972

(22) Filed: Aug. 21, 2015

Related U.S. Application Data
(63) Continuation-in-part of application No. 13/677,215, filed on Nov. 14, 2012.
(60) Provisional application No. 61/559,173, filed on Nov. 14, 2011.

(51) Int. Cl. H04B 3/32; H04L 27/26; H04M 3/00; H04B 17/336

(52) U.S. Cl. CPC H04B 3/32; H04B 17/336; H04L 27/2614; H04M 3/007

(57) ABSTRACT

In the present disclosure, several techniques are proposed to estimate the worst-case crosstalk noise and use it for bit-loading and SRA calculations so that fluctuating crosstalk when PET mode is enabled does not lead to system instability. One of the proposed techniques involves strategically placing some marker tones in the transmitters of the affecting lines. The noise floor may be inferred by interpolating the noise observed on these marker tones (tones that are always-on) and applying to the entire frequency band on the victim line. Another proposed technique involves periodically transmitting a set of marker symbols (fully loaded OFDM symbols), so that a victim channel can estimate the SNRs in a worst case crosstalk scenario.

### CROSS REFERENCE TO RELATED PATENT APPLICATIONS

The present application is a continuation-in-part (CIP) application of U.S. patent application Ser. No. 13/677,215, which was filed on Nov. 14, 2012 and claims the priority benefit of U.S. Provisional Patent Application No. 61/559,173, filed on Nov. 14, 2011. The above-identified applications are incorporated by reference in their entirety.

### TECHNICAL FIELD

The present disclosure generally relates to the field of digital communication and, more particularly, to the management of crosstalk in orthogonal frequency-division multiplexing (OFDM)-based communication systems.

### BACKGROUND

In most OFDM-based communication systems (both wired and wireless), it is common for all communication channels to contribute a significant amount of crosstalk noise or interference to other neighboring communication channels. The crosstalk might be introduced by physically closely-placed channels (e.g., phone line wires) or by operation in a shared medium with imperfect crosstalk cancellation techniques. Data transmission over multiple-input-multiple-output-channels in wireless communications is one example and data transmission based on xDSL standards over phone line wires in a bundle is another example.

FIG. 1 shows a typical asymmetric digital subscriber line (ADSL)/very-high-bit-rate digital subscriber line (VDSL) communication system. A communication channel consists of a pair of twisted copper wire which is situated in a bundle and is surrounded by up to hundreds of pairs of other twisted copper wires. The length of the bundle ranges from a couple of feet to thousands of feet. As shown in FIG. 1, channel B is affected by the transmissions in channel A in the bundle. Accordingly, the term “victim channel” is used to refer to a channel that is affected by transmissions on other channels—as in the case of channel B in this example. The term “affecting channel” is used to refer to a channel that is affecting other channels—as in the case of channel A in this example. The terms “crosstalk” or “interference” are used herein to represent the leakage power experienced by the victim channel due to transmissions on the “affecting channel”.

Without a proper crosstalk cancellation technique, the contribution of crosstalk energy from the affecting line is treated as noise by the victim line. The crosstalk noise in some applications dominates the noise floor seen by the victim line. In order to maintain a stable noise floor without fluctuating crosstalk, these systems have to continuously transmit signals even when there is no payload or user data to transmit. The reason to continuously transmit signals is to ensure that the crosstalk in neighboring channels is steady and the signal-to-noise ratio (SNR) measurements are not affected by varying crosstalk noise, resulting in steady SNR margin and operation without frequent receiver errors or connection drops due to excessive errors in the received data. This was an acceptable technique for several years. However, in recent years, “power savings” and “green operation” have become important design and implementation considerations. To address the power saving requirement in existing always-on communication systems like ADSL and VDSL, it is natural to consider switching off the transmitter when there is no payload data to transmit. As can be seen from FIG. 1, by switching the transmitter on and off rapidly in one channel, the crosstalk noise as experienced by neighboring communications channels is consequently affected, thereby affecting the measured SNR and bit-loading in the neighboring channels. This has become a primary issue in applying power saving techniques that switch off the transmitter when there is no data traffic.

### SUMMARY

In a crosstalk-affected OFDM communications system, a transmitter enters into a “power saving mode”, or power efficient transmission (PET) mode, when there is no payload data to transmit on one or more tones. The transmitter enters into the PET mode by switching off or muting one or more tones that are allocated to carry payload data or periodically switching off the transmitter completely. To aid crosstalk noise estimation on other victim channels, a small number of strategically-placed tones may be transmitted in the transmitter of the affecting line consistently or periodically. These strategically-placed tones are referred to as “marker tones” or “markers”. Depending on the requirement of the application, marker tones can be mapped to fixed constellations or can carry control data or payload data. Marker tones can be at fixed frequencies or vary in frequencies during different OFDM symbols in time following a pre-defined pattern. Alternatively or additionally, a similar approach may be applied to the transmitter of an affecting line by transmitting a small number of strategically-placed fully loaded OFDM symbols periodically in PET operation. These symbols are referred to as “marker symbols”. Estimation of noise power for the victim channel can thus be done by observing these marker tones or marker symbols in a receiver and inferring a noise floor by interpolation between consecutive markers tones or marker symbols.

### BRIEF DESCRIPTION OF THE DRAWINGS

The accompanying drawings are included to provide a further understanding of the disclosure, and are incorporated in and constitute a part of the present disclosure. The drawings illustrate embodiments of the disclosure and, together with the description, serve to explain the principles of the disclosure.

FIG. 1 illustrates a symbol-aligned very-high-bit-rate digital subscriber line 2 (VDSL2) communication system.

FIG. 2 illustrates the signal-to-noise ratio (SNR) in a victim line when an affecting line is idle (not transmitting any payload data).

FIG. 3 illustrates the SNR in a victim line when an affecting line is transmitting payload data.

FIG. 4 illustrates noise estimation during marker tones in accordance with an embodiment of the present disclosure.

FIG. 5 illustrates a VDSL system with asynchronous clock at central office side.

FIG. 6 illustrates power leakage versus symbol alignment offset in accordance with an embodiment of the present disclosure.

FIG. 7 illustrates a block diagram of an example system in accordance with an implementation of the present disclosure.

FIG. 8 illustrates a flowchart of an example process in accordance with an implementation of the present disclosure.

FIG. 9 illustrates a flowchart of an example process in accordance with another implementation of the present disclosure.

FIG. 10 illustrates a flowchart of an example process in accordance with yet another implementation of the present disclosure.

### DETAILED DESCRIPTION OF PREFERRED EMBODIMENTS

### Overview

In a crosstalk-affected OFDM communications system, instead of turning off a transmitter completely for power saving, the transmitter enters into a “power saving mode”, or power efficient transmission (PET) mode, when there is no payload data to transmit. The bits that are to be transferred over a link may be classified as quiet or non-quiet types depending on the content of the bits. A bit that is not associated with payload data traffic and is generated to match the rate between higher layers and physical layer delivery mechanism is called a “quiet bit”. A bit associated with payload data traffic is called a “non-quiet bit”. When mapping the OFDM constellations, if the constellation is generated from quiet bits or bits derived from quiet bits, and provided that the receiver will not be adversely affected, the constellation points may be forced to [0, 0] for those sub-carriers. This will result in a net reduction in the total power transmitted and power consumed by the transmitting device since transmitting [0, 0] does not require any energy on the sub-carrier. Further reductions in power consumption may be possible by shutting down hardware units at the transmitter or receiver when quiet bits and the corresponding sub-carriers are processed.

Examples of communication systems where the power-saving scheme may be applicable include, but are not limited to, OFDM-based communication systems, xDSL systems such as ADSL (ITU-T G.992.x) and VDSL (ITU-T G.993.x), g.INP (a.k.a. ITU-T G.998.4), g.hn (a.k.a. ITU-T G.9961/G.9960/G.9963), IEEE P1901, Homeplug, MOCA, and IEEE 802.11 systems.

Under the power-saving scheme (PET mode), a number of rules are observed and are provided below.

(1) Input bits are processed and mapped to constellation points with real and imaginary components over a number of sub-carriers.

(2) Input bits and all system bits that affect the mapping to the sub-carriers have a per-bit quiet status indicator attached.

(3) Bits derived from operations over quiet only input bits shall generally be classified as quiet bits.

(4) In some operations with quiet only input bits, derived quiet bits may be converted to non-quiet bits. In some operations with non-quiet bits, derived non-quiet bits may be converted to quiet bits.

(5) Bits derived from operations with non-quiet only inputs shall generally be classified as non-quiet bits.

(6) Bits derived from operations with quiet and non-quiet inputs shall generally be classified as non-quiet bits.

(7) In some operations with quiet and non-quiet bits, non-quiet bits may be converted to quiet bits.

(8) When mapping bits to constellations, if only quiet bits are mapped to a sub-carrier then [0, 0] may be mapped to that sub-carrier.

(9) In some cases sub-carriers that are generated only from quiet bits may transmit the original constellation point without forcing it to [0, 0]. The transmission of the original constellation point without forcing it to [0, 0] in such cases may be based on a request from the receiver.

The goal of the mechanism is that when there is idle traffic, i.e., traffic not generated by higher layers but generated for rate matching like ATM/PTM idle cells, such idle traffic may be assigned the quiet status, thus resulting in power savings due to not transmitting on sub-carriers that are supposed to carry this traffic. On the receiver end, it is possible to reconstruct the user traffic and filter out the idle traffic.

Depending on the application or application layer used in a standard, the status of bits may be grouped together leading to further optimization. In one embodiment, byte-based systems or layers may have per-byte quiet/non-quiet status indication. In another embodiment, codeword-based systems may have per-codeword quiet/non-quiet status indication. In yet another embodiment, retransmission systems supporting g.INP may have per-DTU quiet/non-quiet status indication.

Depending on operations used in a standard, several individual operations may be grouped together leading to further optimization and simplification. In these cases, the entire composite operation may operate on a group of bits and change the status of a group of output bits depending on status of all bits in the input group. In one embodiment, in the context of Reed-Solomon (RS) parity generation, if all input bytes are quiet then the whole codeword may be classified as quiet, otherwise the whole codeword may be classified as non-quiet. It is noteworthy that if forward error correction (FEC) information bytes contain a mixture of quiet and non-quiet bytes, then all quiet bytes may be re-classified as non-quiet to allow proper decoding at the receiver. In another embodiment, in the context of DTU formation, if at least one complete or partial input packet transmission mode (PTM) cell in a DTU is non-quiet, then the DTU as a whole may be assigned non-quiet status.

Regarding initial status classification, the following are some examples in which quiet status may be asserted: FEC codewords that contain only idle data as payload, idle PTM cells, idle asynchronous transfer mode (ATM) cells, DTUs in g.INP that contain only idle PTM or ATM cells, link protocol data units (LPDUs) in g.hn that contain dummy or padding payload data, and high-level data link control (HDLC) idle bytes.

On the receiver end, the constellation points are demodulated and then decoded to reconstruct the original data sent by the transmitter. Data bits that were asserted as non-quiet at the transmitter will be unaffected and so should be recoverable at the receiver. Data bits that were asserted as quiet at the transmitter may be decoded incorrectly at the receiver, and may be: (1) identified and dropped, (2) passed on to higher layers as corrupt data, or (3) converted into an appropriate type (e.g., idle ATM cells or PTM cells if supported by the higher layer) that can be transferred to the upper layer. In some cases, the receiver may make some form of estimation as to whether the transmitter has switched to transmitting quiet bits or groups and take appropriate measures to filter the quiet related data, or disable processing units so as to further save power or both.

In a crosstalk-affected OFDM communications system, instead of turning off a transmitter completely for power saving, the transmitter enters into a “power saving mode”, or power efficient transmission (PET) mode, as described above, when there is no payload data to transmit. The transmitter enters into the power efficient transmission mode by dynamically switching off (e.g., mapping to [0,0] which means not allocating power in the frequency spectrum to the tone) most of the tones (e.g., those tones that are mapped to quiet bits) that are allocated to carry payload data whenever there is not payload to send while leaving a small number of strategically-placed tones or some of the OFDM symbols on. These always-on tones or OFDM symbols are referred to as “marker tones” or “markers”. Depending on the requirement of the application, marker tones can be mapped to fixed constellations or can carry control data or some amount of payload data. Estimation of noise power for a victim channel can thus be done by observing these marker tones in a receiver and inferring a noise floor by interpolation between consecutive markers in some cases.

The marker tones can either be mapped to a fixed set of tones during one or more OFDM symbols or, alternatively, they can be mapped to different tones during different OFDM symbols. In some cases the complete OFDM symbols are designated as marker symbols. As long as the victim channel is aware of the pattern used to map the marker tones or marker symbols, the pattern can be utilized to estimate SNR when the crosstalk from neighboring “affecting channels” is at maximum.

The proposed PET technique can achieve a significant amount of power reduction in an OFDM communication system such as ADSL or VDSL. However, the dynamic crosstalk behavior introduced by PET differs from the traditional xDSL crosstalk model and may render system-wide stability an issue.

Under PET mode, one or more of the tones that are assigned to carry payload data traffic are dynamically muted (i.e. mapped to [0,0], which means not allocating power in frequency spectrum to the tone) when there is no payload data to send that is assigned to those tones and makes the crosstalk behavior traffic-dependent. A victim line sees highly unpredictable and time-varying crosstalk from adjacent lines. The training time during which SNR measurement is done in a victim line is critical because the bit-loading is based on the measured SNR. If there is unpredictable or time-varying crosstalk from adjacent lines during this time the resulting bit-loading cannot be applied reliably. If the bit-loading is done when there is no traffic in the affecting lines, it may be higher than what it should be and it may result in instability in the victim line. Further, wide variation in crosstalk noise makes it impossible for the SRA (Seamless Rate Adaptation) as defined in ITU-T G993.2 to work properly because the SNR is dynamically changing.

In the present disclosure, several techniques are proposed to estimate the worst-case crosstalk noise and use it for bit-loading and SRA calculations so that fluctuating crosstalk when PET mode is enabled does not lead to system instability. One of the proposed techniques involves strategically placing some marker tones in the transmitters of the affecting lines. The noise floor may be inferred by interpolating the noise observed on these marker tones (tones that are always-on) and applying to the entire frequency band on the victim line. Another proposed technique involves periodically transmitting a set of marker symbols (fully loaded OFDM symbols), so that a victim channel can estimate the SNRs in a worst case crosstalk scenario.

The basic idea is similar in principle to virtual noise where noise floor is described by a power spectral density (PSD) descriptor as defined in ITU-T G.993.2. By strategically placing some marker tones or marker symbols in the transmitters of the affecting lines, the noise floor may be inferred by interpolating the noise observed on these marker tones or marker symbols and applying to the victim line. The interpolated noise can be stored internally and thus be used for bit-loading or SRA. To simplify the implementation, one possible way of choosing marker tones includes using evenly-distributed tones.

An additional technique uses fully loaded OFDM symbols (marker symbols) sent occasionally to allow victim lines to estimate the SNRs accurately under the worst case crosstalk scenario. This technique can be used on its own or, alternatively, it can also be combined with the techniques that use marker tones to improve the SNR measurement accuracy and stability of connections when PET is enabled on those lines. For example, some of the OFDM symbols may use marker tones and some of the OFDM symbols may be designated as marker symbols. The SNRs may be measured on marker symbols and fine-tuned using the marker tones.

### Example Implementation

### Symbol-Aligned Channels

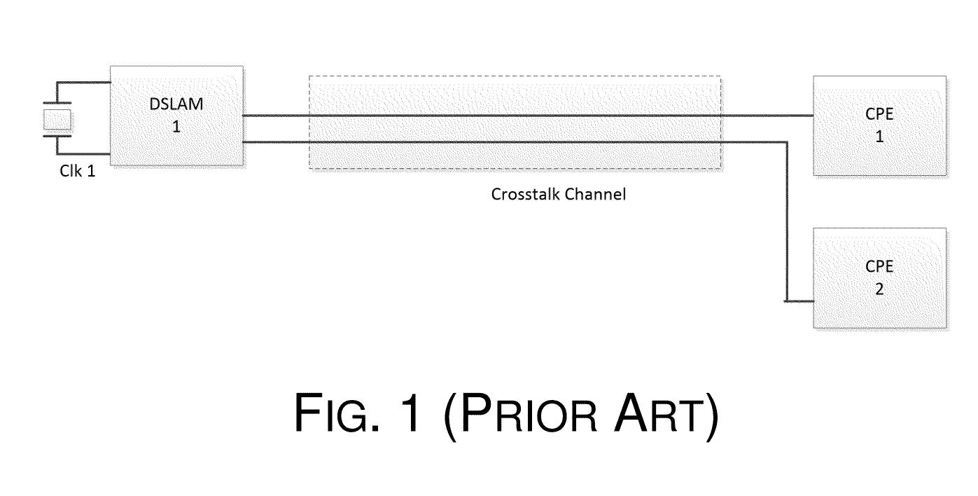

Symbol-aligned channels are the communication channels resulting from synchronous transmission of OFDM symbols on all these channels. The symbol boundaries across all channels are very close to each other (within an error of a few micro seconds for a typical VDSL system running ITU-T G.993.5) and hence orthogonality across all channels is maintained. As an example, a typical symbol-aligned VDSL2 system is depicted in FIG. 1. Client premises equipment (CPE) 1 and CPE 2 are connected to a same DSLAM, and clocks and symbol boundaries are maintained across CPE 1 and CPE 2. Under this configuration, a receiver can estimate crosstalk energy on the marker tones or marker symbols without any difficulty.

### 1. Marker Tones Method

In order to ensure a reliable bit-loading calculation, the worst-case crosstalk estimation where all active lines in a bundle are transmitting at full power is to be assumed. By allocating marker tones in the transmitter of the affecting line, the worst-case estimation is possible by the receiver of the victim line by observing the energy on the marker tones and inferring a crosstalk PSD by interpolation. A marker tone can use a fixed constellation, modulated by a known pattern or modulated by data traffic. The tone indexes for markers are known a-priori and 4QAM (4-point constellation) may be used on these tones to ensure an accurate estimation. The idea is illustrated in the following figures where one affecting line is assumed:

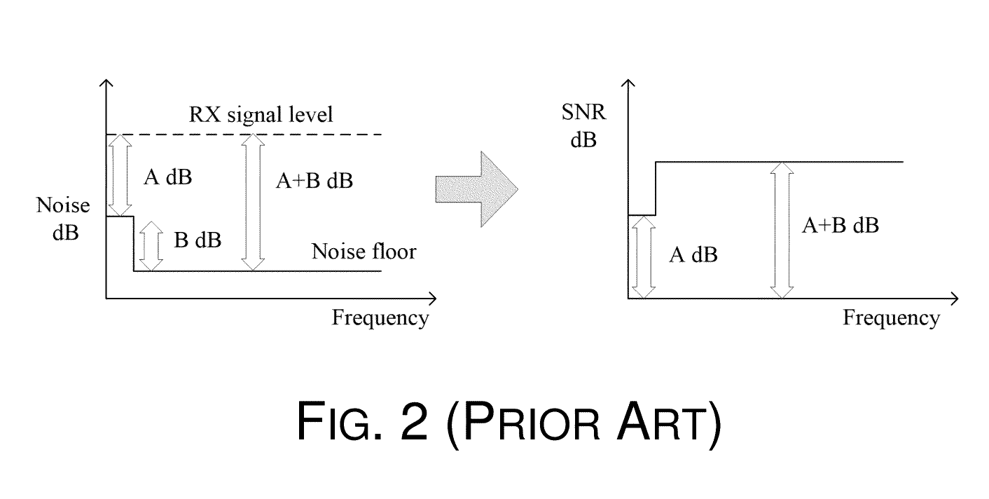

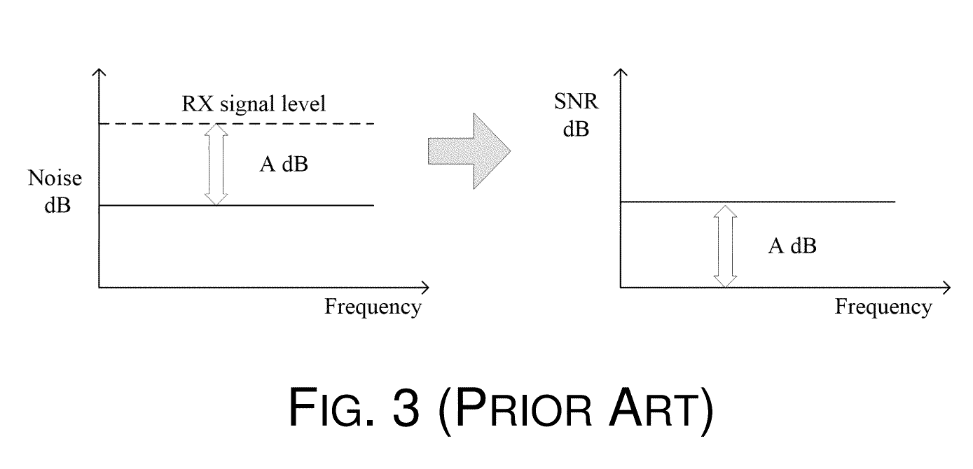

FIG. 2 represents the SNR in a victim line when the affecting line is not transmitting any payload data. The SNR observed by the victim line is high (A+B dB) except in the low frequency region (A dB) where some management overhead data is modulated. In the higher frequency region, the SNR is high (A+B dB) because there is no transmission in that region in the affecting line. The overall SNR is unrealistically high due to no crosstalk in the tones allocated for payload data and will drop to the SNR in FIG. 3 abruptly as soon as payload data is transmitted in the affecting line.

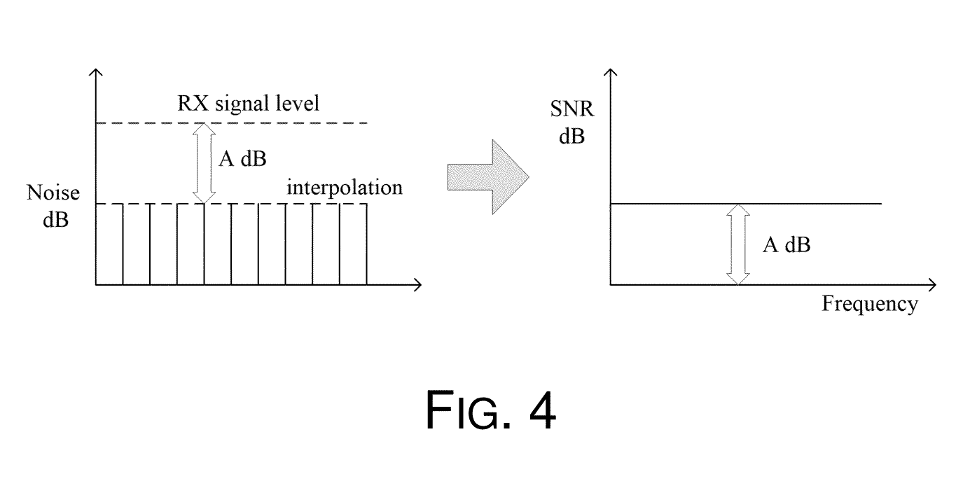

To make the connection robust and to maintain SNR margin, using SNR of FIG. 3 (flat A dB) for bit-loading calculation is desirable. However, there is no guarantee that there will be payload traffic in the affecting line generating crosstalk in the victim line, when the victim line is doing SNR and bit-loading calculation. This problem is solved by modulating some tones in the affecting line evenly in the spectrum and deriving a pseudo noise floor in the victim line by interpolating SNR or noise observed on these tones and applying to the whole band. Alternatively, some or all tones in the marker set are modulated by 4QAM in the affecting line to carry management data instead of dedicating those lines for sending a known pattern. Although this is not necessary, it can lead to better utilization of channel capacity. This idea is illustrated in FIG. 4.

### 2. Marker Symbols Method

Instead of using marker tones, periodically transmitting fully loaded OFDM symbols (marker symbols) can be done so that a victim channel can estimate the SNRs in a worst case crosstalk scenario. If all the lines in the bundle transmit fully loaded OFDM symbols during the same OFDM symbol with the same frequency (e.g., once every 256 symbols, 16 times every 1024 symbols etc.), the SNRs estimated during those symbols may lead to more reliable bit-loading and stable connections. A fully loaded OFDM symbol represents a symbol in which all the active tones (those with bit-loading>=1) are fully loaded with payload data, management data or a known pattern. In other words, those symbols have no muted tones. One straight-forward choice of marker symbols for an ITU-T G.993.5 VDSL system is the SYNC symbols. As specified in ITU-T G.993.5, a SYNC symbol is transmitted every 257 OFDM symbols and is modulated by 4-QAM constellations.

### Example Implementation

### Symbol-Unaligned Channels

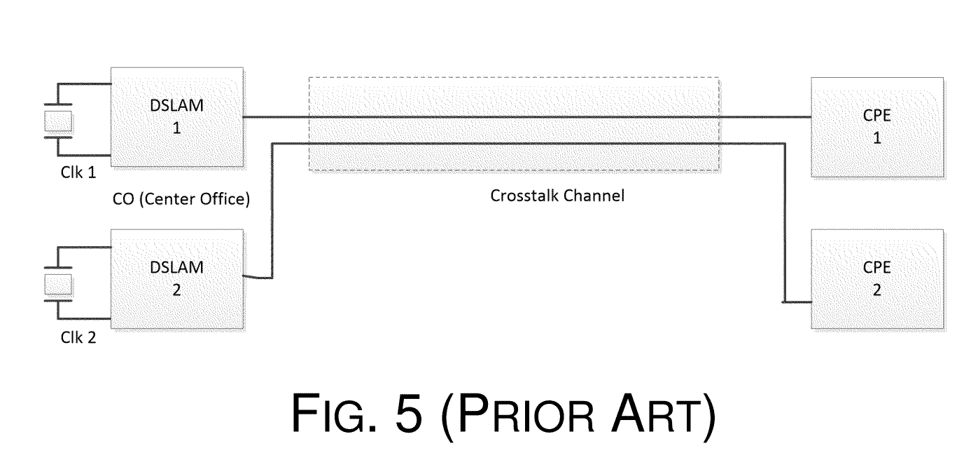

In this case symbols across all communication channels are not aligned and synchronized in time. An example is the ITU-T G.993.2 VDSL2 system as depicted in FIG. 5 where the copper communication channels in the same bundle are fed by different DSLAMs (Digital Subscriber Line Access Multiplexers), each running on its own clock. Since clock or symbol boundary is not aligned in this case, some modification to the techniques using marker tones or marker symbols is needed.

### 1. Marker Tones Method

For a modem operating in an unaligned environment, if this modem is PET aware, it is expected to estimate noise on the marker tones and derive a worst case noise PSD for bit-loading as in the symbol-aligned case. However, a problem arises due to the fact that symbol boundary in each loop may not be aligned. We have found that due to the misaligned symbol boundaries, the accuracy of estimated noise on the marker could vary by more than 10 dB and render the above method useless without any modifications.

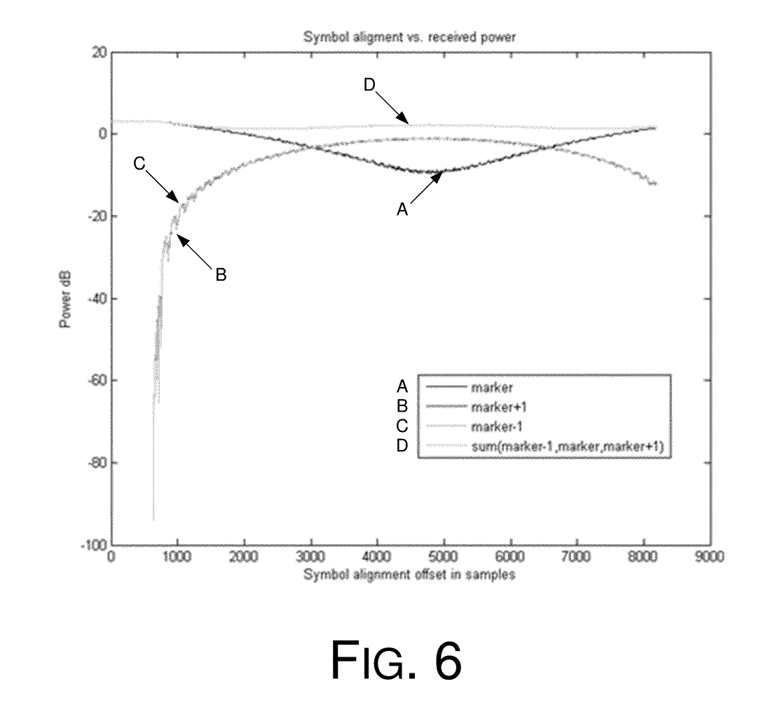

During simulation by the inventors, the worst-case scenario is used to investigate this problem. The affecting line is transmitting marker tones at multiples of bin 64. The constellation for the first symbol for each marker tone comes from a random sequence. The constellation for the second symbol is a 180 degree phase reversal of the first symbol. An IFFT size of 8192, a CE of 640 and a beta window of 128 points is used. The simulation walks through all possible alignment and the observed spectrum by the victim line is shown in FIG. 6.

As can be seen in FIG. 6, as the receiver alignment goes beyond the protection offered by the cyclic extension, the energy from the affecting line leaks into adjacent tones. Assuming that markers described below are implemented in an unaligned bundle (unbundled) environment, a victim line sees a spread spectrum of the markers from the affecting lines. We provide three possible solutions to this problem as described below.

### A. Energy Concentration Method

As the simulation result in FIG. 6 shows, the spread energy of a tone N observed by the victim line is concentrated at tones N−1, N and N+1. With this result in mind, when a victim line performs crosstalk estimation, it sums energies on these three tones and uses the total energy as the noise energy for the specific marker. This method, however, tends to give a more conservative bit-loading, which may lead to somewhat reduced data rates.

### B. Pilot Method

In G.993.2 standard, up to 16 pilots are allowed in the downstream direction. If we select these pilot tones carefully so that each of them is continuous across the symbol boundary with cyclic extension, then theoretically there is no spread energy on these tones and a reliable crosstalk estimation can be made on these tones. The tones that are continuous over symbol boundaries follow the formula below:

N=SymbolLen/(gcd(SymbolLen,CeLen))*ki, ki=1,2,3, etc

For a typical VDSL2 system where SymbolLen=8192 and CeLen=640, N=64*ki. This method would give the best estimation of the crosstalk energies on the marker tones. Note this method requires the marker tones stay at the same phase every symbol hence they cannot be used for data transmission.

### C. Time of Day (ToD) Method

ToD (Time of Day) is a technique used to distribute clock (date, hour, minutes, seconds) in a communication system. A typical ToD clock accuracy for a VDSL system is 3-5 μS. If ToD is implemented in the communication system, it is possible to achieve symbol alignment across all lines with little effort. This case then reduces to aligned scenario and the techniques described earlier for symbol aligned case can then be applied as well. Note that any alternative method that synchronizes the transmission times on different channels enables using the techniques described earlier for the symbol aligned case.

### 2. Marker Symbols Method

The idea of using marker symbols, i.e., periodically transmitting a set of fully loaded OFDM symbols, is the same as described in the symbol-aligned scenario. However, in case of unaligned channels, if the SNR estimation is done leaving enough guard interval (e.g., using middle 16 OFDM symbols among the 32 consecutive OFDM symbols that are fully loaded), it would represent the SNRs during worst case crosstalk and lead to reliable connections with equalized SNR margins. Alternatively, if the modems support ToD then they can use that to transmit fully loaded OFDM symbols at the same time, to allow accurate crosstalk estimation and SNR measurement. Note that any alternative method that synchronizes the transmission times on different lines in the bundle enables using the techniques described earlier for the symbol aligned case.

### Example Implementations

### Apparatus and Processes

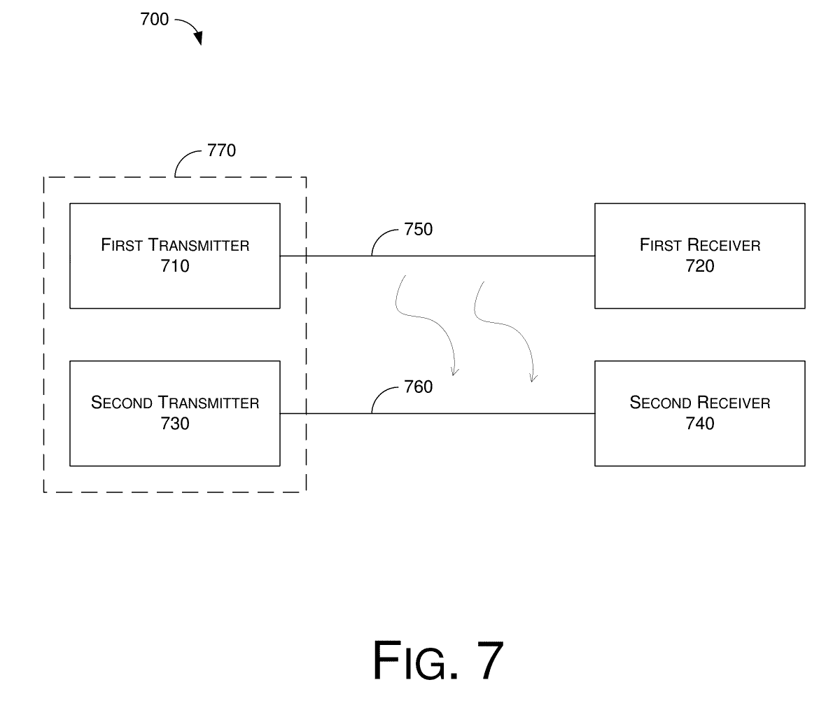

FIG. 7 is a block diagram of an example system 700 in accordance with an implementation of the present disclosure. Example system 700 may perform various functions related to techniques, methods and systems described herein, including example processes 800, 900 and 1000 described below. Example system 700 may be an OFDM-based communication system having at least a transmitter and a receiver not connected directly by a medium. Moreover, example system 700 may be an OFDM-based communication system where crosstalk exists. Example system 700 may include a very-high-bit-rate digital subscriber line 2 (VDSL2) communication system.

Referring to FIG. 7, example system 700 may include a first transmitter 710, a first receiver 720 associated with or otherwise coupled to the first transmitter 710, a second transmitter 730, and a second receiver 740 associated with or otherwise coupled to the second transmitter 730. First receiver 720 may be connected to first transmitter 710 by a first digital data transmission medium 750. Second receiver 740 may be connected to second transmitter 730 by a second digital data transmission medium 760 that is in a vicinity of the first data transmission medium 750. Each of the first digital data transmission medium 750 and the second digital data transmission medium 760 may include metal wires including any of twisted-pair phone lines, cables, power line, or a combination thereof. In some implementations, first transmitter 710 and second transmitter 730 may be part of a first communication apparatus 770.

First transmitter 710 may be configured to generate a signal in a first digital data transmission medium at a first level equivalent to a highest power spectral density (PSD) level expected in the first digital data transmission medium, at one or more predetermined time intervals or on one or more predetermined first subcarriers, or both at the one or more predetermined time intervals and on the one or more predetermined subcarriers. First transmitter 710 may also be configured to transmit data using at least one of one or more subcarriers assigned to carry payload data traffic in an event that there is payload data traffic assigned to the at least one of the one or more subcarriers. First transmitter 710 may be further configured to mute the at least one of the one or more subcarriers in an event that there is no payload data traffic assigned to the at least one of the one or more subcarriers. For instance, in muting the at least one of the one or more subcarriers, first transmitter 710 may allocate no power in a frequency spectrum to the at least one of the one or more subcarriers.

Second receiver 740 may be configured to determine noise levels observed in a second digital data transmission medium 760 that is in a vicinity of the first digital data transmission medium 750 at the one or more predetermined time intervals or on the one or more predetermined subcarriers, or both at the one or more predetermined time intervals and on the one or more predetermined subcarriers by calculating a signal-to-noise ratio (SNR) or signal-to-interference ratio (SIR) for the second digital data transmission medium. Second receiver 740 may also be configured to estimate by interpolation in time, in frequency, or in both time and frequency a worst-case noise level across a full transmission spectrum in the second digital data transmission medium. Second receiver 740 may be further configured to derive a bit-loading for data transmission over the second digital data transmission medium based on the worst-case noise level.

Second receiver 740 may be configured to estimate a noise floor by computing a SNR or a SIR of a signal power of one or more predetermined signals on a direct path to a total noise power at one or more predetermined subcarriers at one or more predetermined time intervals. In estimating, second receiver 740 may perform a number of operations. For instance, second receiver 740 may sum energy of noise over the subcarriers in each group of consecutive subcarriers to derive a summed noise energy for a representative subcarrier in each group of consecutive subcarriers. Additionally, second receiver 740 may derive a worst-case noise for these representative subcarriers. Furthermore, second receiver 740 may derive the worst-case noise PSD mask by interpolating over frequency the summed noise energy in a representative subcarrier in each group of consecutive subcarriers across a complete transmission spectrum used for bit-loading. Second receiver 740 may be further configured to interpolate over frequency a noise level on the one or more predetermined subcarriers to derive a worst-case noise PSD mask across a complete transmission spectrum used for bit-loading. For instance, in interpolating, second receiver 740 may derive a virtual-noise PSD mask for bit-loading in a VDSL2 communication system.

Second transmitter 730 may be configured to transmit data using at least one of one or more subcarriers assigned to carry payload data traffic in an event that there is payload data traffic assigned to the at least one of the one or more subcarriers. Second transmitter 730 may be also configured to mute the at least one of the one or more subcarriers assigned to carry payload data traffic in an event that there is no payload data traffic assigned to the at least one of the one or more subcarriers. For instance, in muting the at least one of the one or more subcarriers, second transmitter 730 may allocate no power in a frequency spectrum to the at least one of the one or more subcarriers.

The one or more predetermined subcarriers may include pilot tones in a VDSL2 communication system. The one or more subcarriers may be continuous across symbol boundaries. The one or more subcarriers may include one or more groups of consecutive subcarriers with a subcarrier designated as a representative subcarrier within each group. Each group of consecutive subcarriers may be spaced equally or spaced in a predetermined manner across a communication spectrum. Each of the first digital data transmission medium 750 and the second digital data transmission medium 760 may carry the one or more predetermined signals transmitted on the one or more predetermined subcarriers at the one or more predetermined time intervals at the first PSD level equivalent to the highest PSD level expected.

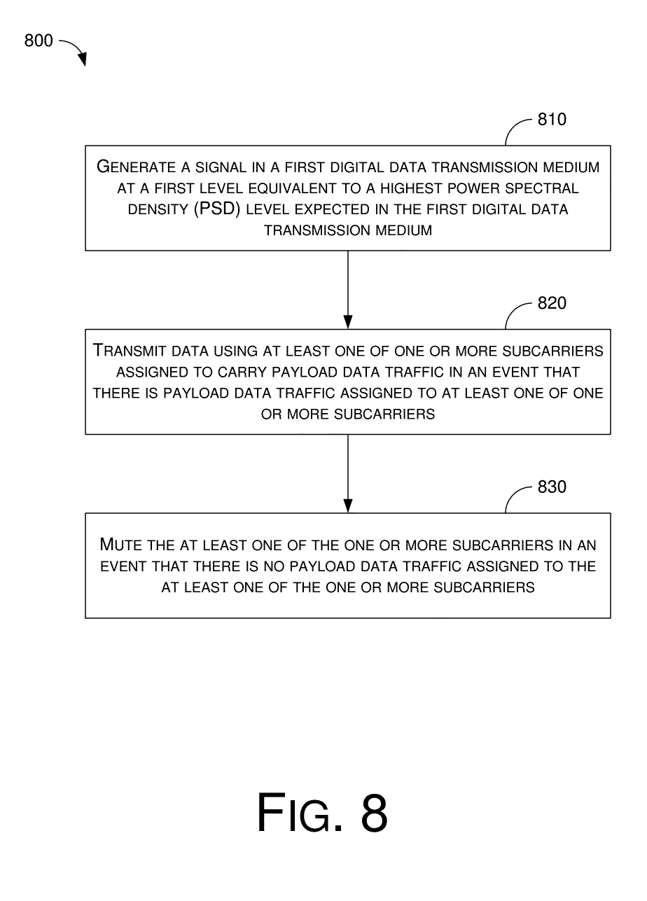

FIG. 8 is a flowchart of an example process 800 in accordance with an implementation of the present disclosure. Example process 800 may include one or more operations, actions, or functions as represented by one or more of blocks 810, 820 and 830. Although illustrated as discrete blocks, various blocks may be divided into additional blocks, combined into fewer blocks, or eliminated, depending on the desired implementation. Example process 800 may be implemented in an OFDM-based communication system having at least a transmitter and a receiver not connected directly by a medium, e.g., example system 700. For illustrative purposes, operations of example process 800 are described below in the context of being performed by components of example system 700. Example process 800 may begin at block 810.

At 810, example process 800 may involve first transmitter 710 generating a signal in a first digital data transmission medium at a first level equivalent to a highest power spectral density (PSD) level expected in the first digital data transmission medium, at one or more predetermined time intervals or on one or more predetermined first subcarriers, or both at the one or more predetermined time intervals and on the one or more predetermined subcarriers. Block 810 may be followed by block 820.

At 820, example process 800 may involve first transmitter 710 transmitting data using at least one of one or more subcarriers assigned to carry payload data traffic in an event that there is payload data traffic assigned to the at least one of the one or more subcarriers. Block 820 may be followed by block 830.

At 830, example process 800 may involve first transmitter 710 muting the at least one of the one or more subcarriers in an event that there is no payload data traffic assigned to the at least one of the one or more subcarriers.

In some implementations, example process 800 may involve second receiver 740 determining noise levels observed in a second digital data transmission medium 760 that is in a vicinity of the first digital data transmission medium 750 at the one or more predetermined time intervals or on the one or more predetermined subcarriers, or both at the one or more predetermined time intervals and on the one or more predetermined subcarriers by calculating a signal-to-noise ratio (SNR) or signal-to-interference ratio (SIR) for the second digital data transmission medium. Additionally, example process 800 may involve second receiver 740 estimating by interpolation in time, in frequency, or in both time and frequency a worst-case noise level across a full transmission spectrum in the second digital data transmission medium. Moreover, example process 800 may involve second receiver 740 deriving a bit-loading for data transmission over the second digital data transmission medium based on the worst-case noise level.

In some implementations, in muting the at least one of the one or more subcarriers, example process 800 may involve first transmitter 710 allocating no power in a frequency spectrum to the at least one of the one or more subcarriers.

In some implementations, the one or more predetermined subcarriers may include pilot tones in a very-high-bit-rate digital subscriber line 2 (VDSL2) communication system.

In some implementations, the medium may include metal wires including any of twisted-pair phone lines, cables, power line, or a combination thereof.

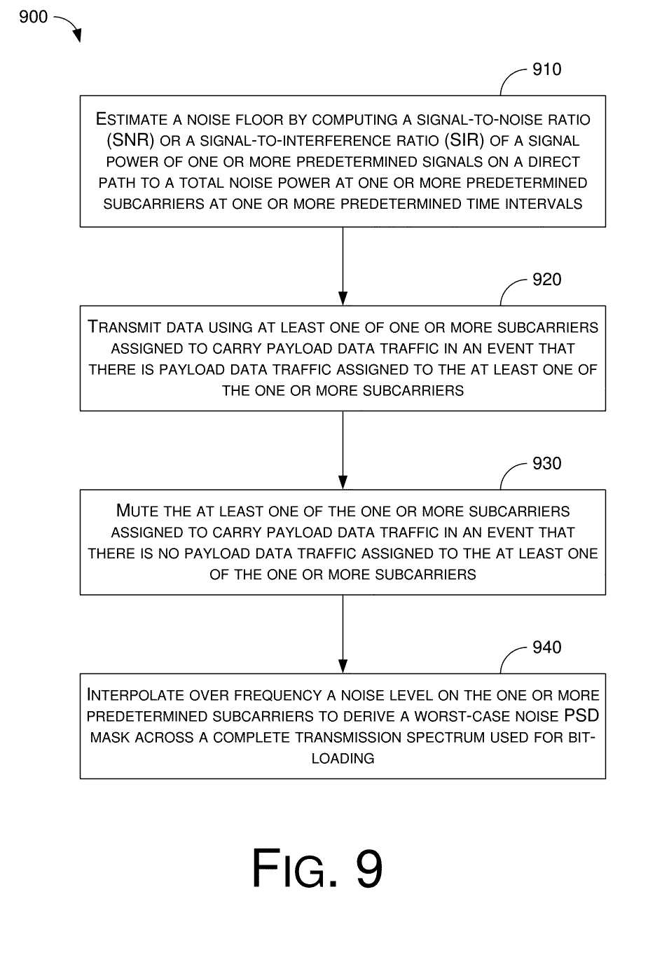

FIG. 9 is a flowchart of an example process 900 in accordance with an implementation of the present disclosure. Example process 900 may include one or more operations, actions, or functions as represented by one or more of blocks 910, 920, 930 and 940. Although illustrated as discrete blocks, various blocks may be divided into additional blocks, combined into fewer blocks, or eliminated, depending on the desired implementation. Example process 900 may be implemented in an OFDM-based communication system where crosstalk exists, e.g., example system 700. For illustrative purposes, operations of example process 900 are described below in the context of being performed by components of example system 700. Example process 900 may begin at block 910.

At 910, example process 900 may involve second receiver 740 estimating a noise floor by computing a signal-to-noise ratio (SNR) or a signal-to-interference ratio (SIR) of a signal power of one or more predetermined signals on a direct path to a total noise power at one or more predetermined subcarriers at one or more predetermined time intervals. The second receiver 740 may be connected to a second transmitter 730 by a second digital data transmission medium 760 that is in a vicinity of a first data transmission medium 750. The first data transmission medium may connect a first transmitter 710 and a first receiver 720 of the OFDM-based communication system (e.g., example system 700). The first data transmission medium may carry the one or more predetermined signals transmitted on the one or more predetermined subcarriers at the one or more predetermined time intervals at a first power spectral density (PSD) level equivalent to a highest PSD level expected. Block 910 may be followed by block 920.

At 920, example process 900 may involve second transmitter 730 transmitting data using at least one of one or more subcarriers assigned to carry payload data traffic in an event that there is payload data traffic assigned to the at least one of the one or more subcarriers. Block 920 may be followed by block 930.

At 930, example process 900 may involve second transmitter 730 muting the at least one of the one or more subcarriers assigned to carry payload data traffic in an event that there is no payload data traffic assigned to the at least one of the one or more subcarriers. Block 930 may be followed by block 940.

At 940, example process 900 may involve second receiver 740 interpolating over frequency a noise level on the one or more predetermined subcarriers to derive a worst-case noise PSD mask across a complete transmission spectrum used for bit-loading.

In some implementations, in muting the at least one of the one or more subcarriers, example process 900 may involve second transmitter 730 allocating no power in a frequency spectrum to the at least one of the one or more subcarriers.

In some implementations, the OFDM-based communication system may include a very-high-bit-rate digital subscriber line 2 (VDSL2) communication system.

In some implementations, the one or more predetermined subcarriers may include pilot tones in a VDSL2 communication system.

In some implementations, the one or more predetermined subcarriers may be continuous across symbol boundaries.

In some implementations, in interpolating, example process 900 may involve second receiver 740 deriving a virtual-noise PSD mask for bit-loading in a VDSL2 communication system.

In some implementations, the one or more subcarriers may include one or more groups of consecutive subcarriers with a subcarrier designated as a representative subcarrier within each group. Each group of consecutive subcarriers may be spaced equally or spaced in a predetermined manner across a communication spectrum. Moreover, in estimating, example process 900 may involve second receiver 740 performing a number of operations. For instance, example process 900 may involve second receiver 740 summing energy of noise over the subcarriers in each group of consecutive subcarriers to derive a summed noise energy for a representative subcarrier in each group of consecutive subcarriers. Additionally, example process 900 may involve second receiver 740 deriving a worst-case noise for these representative subcarriers. Furthermore, example process 900 may involve second receiver 740 deriving the worst-case noise PSD mask by interpolating over frequency the summed noise energy in a representative subcarrier in each group of consecutive subcarriers across a complete transmission spectrum used for bit-loading.

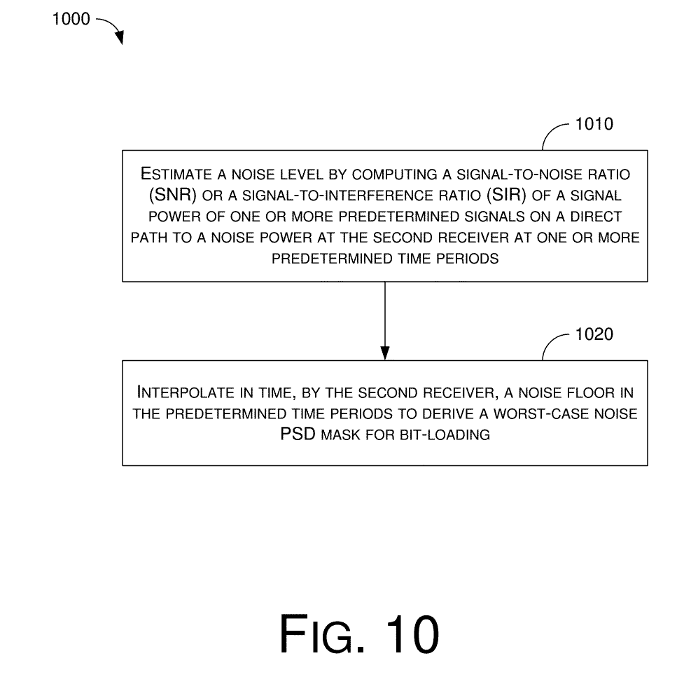

FIG. 10 is a flowchart of an example process 1000 in accordance with an implementation of the present disclosure. Example process 1000 may include one or more operations, actions, or functions as represented by one or more of blocks 1010 and 1020. Although illustrated as discrete blocks, various blocks may be divided into additional blocks, combined into fewer blocks, or eliminated, depending on the desired implementation. Example process 1000 may be implemented in an OFDM-based communication system where crosstalk exists, e.g., example system 700. For illustrative purposes, operations of example process 1000 are described below in the context of being performed by components of example system 700. Example process 1000 may begin at block 1010.

At 1010, example process 1000 may involve second receiver 740 estimating a noise level by computing a signal-to-noise ratio (SNR) or a signal-to-interference ratio (SIR) of a signal power of one or more predetermined signals on a direct path to a noise power at the second receiver at one or more predetermined time periods. The second receiver 740 may be connected to a second transmitter 730 by a second digital data transmission medium 760 that is in a vicinity of a first digital data transmission medium 750. The first data transmission medium may connect a first transmitter 710 and a first receiver 720 of the OFDM-based communication system (e.g., example system 700). The first data transmission medium may carry the one or more predetermined signals transmitted on some or all of the one or more predetermined subcarriers during the one or more predetermined time periods at a first power spectral density (PSD) level equivalent to a highest PSD level expected, while transmitting data using at least one of the one or more subcarriers assigned to carry payload data traffic in an event that there is payload data traffic assigned to the at least one of the one or more subcarriers. The at least one of the one or more subcarriers assigned to carry payload data traffic may be muted in an event that there is no payload data traffic assigned to the at least one of the one or more subcarriers. Block 1010 may be followed by block 1020.

At 1020, example process 1000 may involve second receiver 740 interpolating in time, by the second receiver, a noise floor in the predetermined time periods to derive a worst-case noise PSD mask for bit-loading.

In some implementations, in interpolating, example process 1000 may involve second receiver 740 deriving a virtual-noise PSD mask for bit-loading in a very-high-bit-rate digital subscriber line 2 (VDSL2) communication system.

In some implementations, the OFDM-based communication system may include a VDSL2 communication system.

In some implementations, the predetermined time periods may include a time when the first transmitter transmits a SYNC symbol in a VDSL2 communication system.

In some implementations, the predetermined time periods may be synchronized between the transmitters and the receivers based on the timing information provided by the time-of-day (ToD) protocol in a VDSL2 communication system.

In some implementations, the one or more predetermined signals may include a SYNC symbol in a VDSL2 communication system.

### CONCLUSION

By carefully choosing marker tones and marker symbols and making the communication system PET-aware, the bursty crosstalk PSD issue of PET can be solved completely. A small amount of complexity introduced by implementing PET and PET-aware techniques, can lead to generous rewards in terms of power-saving.

Although select embodiments are described above, they are not intended to limit the scope of the present disclosure. It will be apparent to those skilled in the art that various modifications and variations can be made to the disclosed embodiments of the present disclosure without departing from the scope or spirit of the present disclosure. In view of the foregoing, the scope of the present disclosure shall be defined by the following claims and their equivalents.

What is claimed is:

1. A method, implemented in an orthogonal frequency-division multiplexing (OFDM)-based communication system having at least a transmitter and a receiver not connected directly by a medium, comprising:
generating, by the transmitter, a signal in a first digital data transmission medium at a first level equivalent to a highest power spectral density (PSD) level expected in the first digital data transmission medium, at one or more predetermined time intervals or on one or more predetermined subcarriers, or both at the one or more predetermined time intervals and on the one or more predetermined subcarriers;
transmitting data using at least one of one or more subcarriers assigned to carry payload data traffic in an event that there is payload data traffic assigned to the at least one of the one or more subcarriers; and
muting the at least one of the one or more subcarriers in an event that there is no payload data traffic assigned to the at least one of the one or more subcarriers.

2. The method of claim 1, further comprising:
determining, by the receiver, noise levels observed in a second digital data transmission medium that is in a vicinity of the first digital data transmission medium at the one or more predetermined time intervals or on the one or more predetermined subcarriers, or both at the one or more predetermined time intervals and on the one or more predetermined subcarriers by calculating a signal-to-noise ratio (SNR) or signal-to-interference ratio (SIR) for the second digital data transmission medium;
estimating by interpolation, by the receiver, in time, in frequency, or in both time and frequency a worst-case noise level across a full transmission spectrum in the second digital data transmission medium; and
deriving a bit-loading for data transmission over the second digital data transmission medium based on the worst-case noise level.

3. The method of claim 1, wherein the muting of the at least one of the one or more subcarriers comprises allocating no power in a frequency spectrum to the at least one of the one or more subcarriers.

4. The method of claim 1, wherein the one or more predetermined subcarriers comprise pilot tones in a very-high-bit-rate digital subscriber line 2 (VDSL2) communication system.

5. The method of claim 1, wherein the medium comprises metal wires including any of twisted-pair phone lines, cables, power line, or a combination thereof.

6. A method, implemented in an orthogonal frequency-division multiplexing (OFDM)-based communication system where crosstalk exists, comprising:
estimating, by a second receiver of the OFDM-based communication system, a noise floor by computing a signal-to-noise ratio (SNR) or a signal-to-interference ratio (SIR) of a signal power of one or more predetermined signals on a direct path to a total noise power at one or more predetermined subcarriers at one or more predetermined time intervals,
wherein:
the second receiver is connected to a second transmitter by a second digital data transmission medium that is in a vicinity of a first data transmission medium,
the first data transmission medium connects a first transmitter and a first receiver of the OFDM-based communication system, and
the first data transmission medium carries the one or more predetermined signals transmitted on the one or more predetermined subcarriers at the one or more predetermined time intervals at a first power spectral density (PSD) level equivalent to a highest PSD level expected;
transmitting data using at least one of one or more subcarriers assigned to carry payload data traffic in an event that there is payload data traffic assigned to the at least one of the one or more subcarriers;
muting the at least one of the one or more subcarriers assigned to carry payload data traffic in an event that there is no payload data traffic assigned to the at least one of the one or more subcarriers; and
interpolating over frequency, by the second receiver, a noise level on the one or more predetermined subcarriers to derive a worst-case noise PSD mask across a complete transmission spectrum used for bit-loading.

7. The method of claim 6, wherein the muting of the at least one of the one or more subcarriers comprises allocating no power in a frequency spectrum to the at least one of the one or more subcarriers.

8. The method of claim 6, wherein the OFDM-based communication system comprises a very-high-bit-rate digital subscriber line 2 (VDSL2) communication system.

9. The method of claim 6, wherein the one or more predetermined subcarriers comprise pilot tones in a very-high-bit-rate digital subscriber line 2 (VDSL2) communication system.

10. The method of claim 6, wherein the one or more predetermined subcarriers are continuous across symbol boundaries.

11. The method of claim 6, wherein the interpolating comprises deriving a virtual-noise PSD mask for bit-loading in a very-high-bit-rate digital subscriber line 2 (VDSL2) communication system.

12. The method of claim 6, wherein the one or more subcarriers comprise one or more groups of consecutive subcarriers with a subcarrier designated as a representative subcarrier within each group, wherein each group of consecutive subcarriers are spaced equally or spaced in a predetermined manner across a communication spectrum, wherein the estimating comprises:
summing energy of noise over the subcarriers in each group of consecutive subcarriers to derive a summed noise energy for a representative subcarrier in each group of consecutive subcarriers;
deriving a worst-case noise for these representative subcarriers; and
deriving the worst-case noise PSD mask by interpolating over frequency the summed noise energy in a representative subcarrier in each group of consecutive subcarriers across a complete transmission spectrum used for bit-loading.

13. A method, implemented in an orthogonal frequency-division multiplexing (OFDM)-based communication system where crosstalk exists, comprising:
estimating, by a second receiver of the OFDM-based communication system, a noise level by computing a signal-to-noise ratio (SNR) or a signal-to-interference ratio (SIR) of a signal power of one or more predetermined signals on a direct path to a noise power at the second receiver at one or more predetermined time periods,
wherein the second receiver is connected to a second transmitter by a second digital data transmission medium that is in a vicinity of a first digital data transmission medium,
wherein the first data transmission medium connects a first transmitter and a first receiver of the OFDM-based communication system,
wherein the first data transmission medium carries the one or more predetermined signals transmitted on some or all of the one or more predetermined subcarriers during the one or more predetermined time periods at a first power spectral density (PSD) level equivalent to a highest PSD level expected, while transmitting data using at least one of the one or more subcarriers assigned to carry payload data traffic in an event that there is payload data traffic assigned to the at least one of the one or more subcarriers, and
wherein the at least one of the one or more subcarriers assigned to carry payload data traffic is muted in an event that there is no payload data traffic assigned to the at least one of the one or more subcarriers.

14. The method of claim 13, further comprising:
interpolating in time, by the second receiver, a noise floor in the predetermined time periods to derive a worst-case noise PSD mask for bit-loading.

15. The method of claim 14, wherein the interpolating comprises deriving a virtual-noise PSD mask for bit-loading in a very-high-bit-rate digital subscriber line 2 (VDSL2) communication system.

16. The method of claim 13, wherein the OFDM-based communication system comprises a very-high-bit-rate digital subscriber line 2 (VDSL2) communication system.

17. The method of claim 13, wherein the predetermined time periods comprise a time when the first transmitter transmits a SYNC symbol in a very-high-bit-rate digital subscriber line 2 (VDSL2) communication system.

18. The method of claim 13, wherein the predetermined time periods are synchronized between the transmitters and the receivers based on the timing information provided by the time-of-day (ToD) protocol in a very-high-bit-rate digital subscriber line 2 (VDSL2) communication system.

19. The method of claim 13, wherein the one or more predetermined signals comprise a SYNC symbol in a very-high-bit-rate digital subscriber line 2 (VDSL2) communication system.
